(19) United States
(12) Patent Application Publication
(10) Pub. No.: US 2018/0181654 A1
(43) Pub. Date: Jun. 28, 2018

(54) MODULAR PROJECTILE WITH MULTIPLE FUNCTIONALITY

(71) Applicant: Russell YOUNG, Hong Kong (HK)

(72) Inventor: Russell YOUNG, Hong Kong (HK)

(21) Appl. No.: 15/388,236

(22) Filed: Dec. 22, 2016

(51) Int. Cl. G06F 17/30; A63H 33/18; G11B 27/17

(52) U.S. Cl. CPC G06F 17/30749; G11B 27/17; A63H 33/18

(57) ABSTRACT

A projectile in form of a spherical ball, a prolate spheroid ball, an oblate spheroid ball, a missile-shaped projectile, a tubular projectile, or a cone-shaped projectile, comprising electronic circuitries for performing at least one of projectile motion, impact, speed, force, rotation, gyration, and vibration sensing, interactive light and sound generation, projectile location tracking, data communication, and user control interfacing; and compartments or cavities in, and/or subsurface concavities around the main body of the projectile, each compartment, cavity, or subsurface concavity is configured to accommodate and allow attachment of an interchangeable module; wherein the one or more interchangeable modules comprises at least one of speaker modules, light modules, tail modules, logo panel modules, light modules, electronic display modules, wing modules, and fin modules.

### BACKGROUND

The present invention is generally related to projectiles used in sports, recreations, and play. More particularly, the present invention is related to projectiles with electronics for generating sounds and lights, providing various user interactivities, facilitating data communications and other functionalities.

### SUMMARY OF THE INVENTION

In accordance to various embodiments of the present invention, provided is a projectile in the general shape of a spherical ball, a prolate spheroid ball, an oblate spheroid ball, a missile-shaped projectile, a tubular projectile, or a cone-shaped projectile. An ordinarily skilled person in the art would appreciate that other shapes are also possible without deviating from the principle of the present invention.

In accordance to one aspect of the present invention, the projectile is having a body that houses one or more electronic circuitries. The electronic circuitries are for implementing various functionalities including, but not limited to, sensing of motion, impact, speed, force, rotation, gyration, and/or vibration of the projectile; interactive light and sound generation; location tracking; data communication; battery power supply management, recharge, and dispensary; and user control interfacing. The electronic circuitries include, but not limited to, speedometers, accelerometers, impact monitors, position sensors, gyroscopic sensors, Global Positioning System (GPS) receivers, light sensors, radio transmitters, radio receivers, radio transceivers, electroacoustic transducers, audio signal processors, microcontrollers, memory devices, light-emitting devices, light-emitting device drivers, battery power supply circuitries, Wi-Fi communication processing components, Bluetooth communication processing components, near field contact (NFC) communication processing components, and wired data communication ports.

In accordance to another aspect, the light generation is controlled by a light generation decision tree implemented by one or more specialized processors with signal input from one or more motion and impact sensors. Based on events detected, the specialized processors generate event-driven signal output driving one or more light-emitting devices, such as light emitting diodes (LEDs). In accordance to another aspect, the sound generation is controlled by an audio decision tree implemented by one or more specialized processors with signal input from one or more motion and impact sensors. Based on events detected, the specialized processors generate event-driven signal output driving one or more electroacoustic transducers.

In accordance to one embodiment, the main body internal structure of the projectile can be of solid construction, air-filled, lattice structure, construction from interlocking parts, or any combination thereof. The main body surface of the projectile can either be smooth, of lattice-like construction with holes or dents, or of a combination thereof.

In accordance to one embodiment, the main body of the projectile comprises one or more compartments or cavities for enclosing the aforesaid electronic circuitries. In one exemplary embodiment, one end of the main body includes a compartment within which a speaker is secured. The compartments can also be configured to accommodate interchangeable modules.

Modularity of the projectile is achieved by having compartments or cavities within the main body of the projectile, and/or subsurface concavities around the main body of the projectile. These compartments or cavities and/or subsurface concavities are configured to enclose or provide attachment for specially designed interchangeable modules. These interchangeable modules include, but not limited to, specialized electronic circuitries for special or customized functionalities such as certain LED arrangements for different lighting patterns, other light-emitting devices, more powerful speakers, light generation controllers, sound generation controllers, and extra battery packs, and peripheral accessories such as wings, fins, tails, and aerodynamic whistles, logo panels, advertisement panels, and other graphical design panels. By attaching different interchangeable modules to the compartments, the physical outlook and shape of the projectile can be changed, and its interactive lights and/or sound generation behavior can also be changed.

In yet another embodiment, the projectile's electronic circuitries include memory devices, Wi-Fi communication processing components, Bluetooth communication processing components, near field contact (NFC) communication processing components, and/or wired data communication ports, which enable the collection and storage of real-time data such as flight time, velocity, and locations of the projectile, and the exchange of this collected data with external systems (i.e. a mobile computing device) for display and analysis.

### BRIEF DESCRIPTION OF THE DRAWINGS

Embodiments of the invention are described in more details hereinafter with reference to the drawings, in which:

FIG. 1 shows an embodiment of a projectile in accordance to the present invention;

FIG. 2 shows the sound module and the corresponding front compartment of the projectile shown in FIG. 1;

FIG. 3 shows the logo panel module of the projectile shown in FIG. 1;

FIG. 4a shows one embodiment of battery storage of the projectile shown in FIG. 1;

FIG. 4b shows another embodiment of battery storage of the projectile shown in FIG. 1;

FIG. 5a shows the modularity of one embodiment of a projectile in accordance to the present invention;

FIG. 5b shows three exemplary embodiments of interchangeable module in accordance to the present invention;

FIG. 5c shows two exemplary embodiments of interchangeable side module in accordance to the present invention;

FIG. 6 illustrates an audio decision tree in accordance to the present invention;

FIG. 7 illustrates another audio decision tree in accordance to the present invention; and

FIG. 8 illustrates yet another audio decision tree in accordance to the present invention.

### DETAILED DESCRIPTION

In the following description, projectiles with modularity and interactive light and sound generation capabilities and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance to various embodiments of the present invention, provided is a projectile in the general shape of a spherical ball, a prolate spheroid ball, an oblate spheroid ball, a missile-shaped projectile, a tubular projectile, or a cone-shaped projectile. An ordinarily skilled person in the art would appreciate that other shapes are also possible without deviating from the principle of the present invention.

In accordance to one aspect of the present invention, the projectile is having a body that houses one or more electronic circuitries. The electronic circuitries are for implementing various functionalities including, but not limited to, sensing of motion, impact, speed, force, rotation, gyration, and/or vibration of the projectile; interactive light and sound generation; location tracking; data communication; battery power supply management, recharge, and dispensary; and user control interfaces. The electronic circuitries include, but not limited to, speedometers, accelerometers, impact monitors, position sensors, gyroscopic sensors, Global Positioning System (GPS) receivers, light sensors, radio transmitters, radio receivers, radio transceivers, electroacoustic transducers, audio signal processors, microcontrollers, memory devices, light-emitting devices, light-emitting device drivers, and battery power supply circuitries, Wi-Fi communication processing components, Bluetooth communication processing components, near field contact (NFC) communication processing components, and wired data communication ports.

In accordance to another aspect, the light generation is controlled by a light generation decision tree implemented by one or more specialized processors with signal input from one or more motion and impact sensors. Based on events detected, the specialized processors generate event-driven signal output driving one or more light-emitting devices, such as light emitting diodes (LEDs). In accordance to another aspect, the sound generation is controlled by an audio decision tree implemented by one or more specialized processors with signal input from one or more motion and impact sensors. Based on events detected, the specialized processors generate event-driven signal output driving one or more electroacoustic transducers.

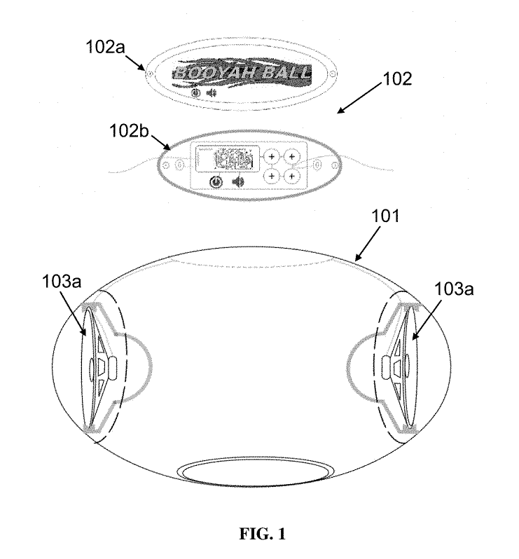

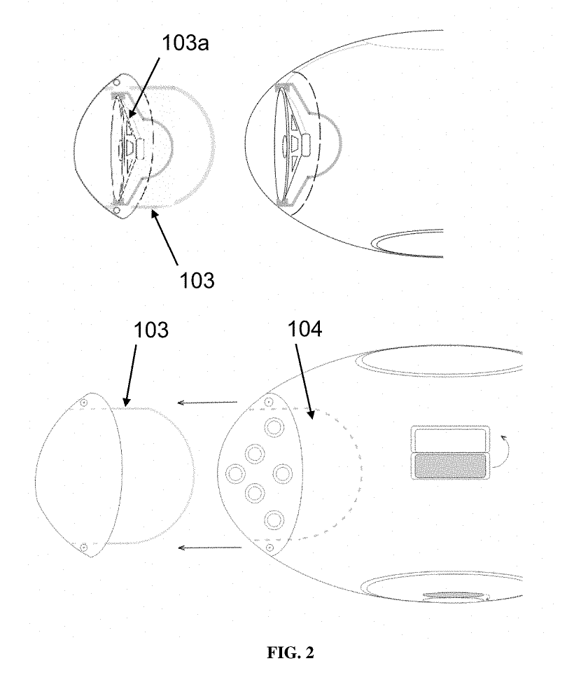

Referring to FIGS. 1-2. In accordance to one exemplary embodiment, the projectile comprises a main body 101, a logo panel 102, and one or two electroacoustic transducers 103a embedded in the main body 101. In this exemplary embodiment, the projectile is a prolate spheroid ball. Its main body 101 has two compartments or cavities 104 one at each end of the prolate spheroid ball shaped main body 101. Each of the compartments is to accommodate a separable speaker module 103. Other embodiments with different placements of speaker modules are possible. The speakers can also be built-in and fixed within cavities of the projectile.

In one embodiment, the main body 101 also has a subsurface compartment or cavity at its top side for accommodating the logo panel 102; and the logo panel 102 is designed to fit and cover the subsurface concavity. In other embodiment, the logo panel 102 is built-in to the main body 101. In another embodiment, the logo panel bottom 102b is built-in to the main body 101. In any of these three embodiments, the logo panel 102, or the top cover 102a, is an interchangeable part of the projectile. In various embodiments, the logo panel 102 has a top cover 102a and a bottom plate 102b forming a shell for housing some of the electronic circuitries, which may include one or more of speedometers, accelerometers, impact monitors, speed sensors, force sensors, vibration sensors, position sensors, gyroscopic sensors, light sensors, and GPS receivers, and one or more of audio signal processors, microcontrollers, memory devices, and light-emitting device drivers. These electronic circuitries can be implemented as integrated circuits (ICs).

The logo panel 102 may also have one or more light-emitting devices, such as LEDs, attached on its bottom and in specifically designed layout. The logo panel 102 can be made of translucent material such that light emitted from the light-emitting devices can be directed internally and/or externally to the projectile. With different graphics design on the top surface, together with the different layout of light-emitting devices, different audio data, light generation pattern data, light generation decision tree data, and/or audio decision tree data stored in the memory devices for playback, different outlooks and themes of the projectile can be achieved easily by swapping different logo panels, or by swapping parts of the logo panel, top cover, and/or bottom plate.

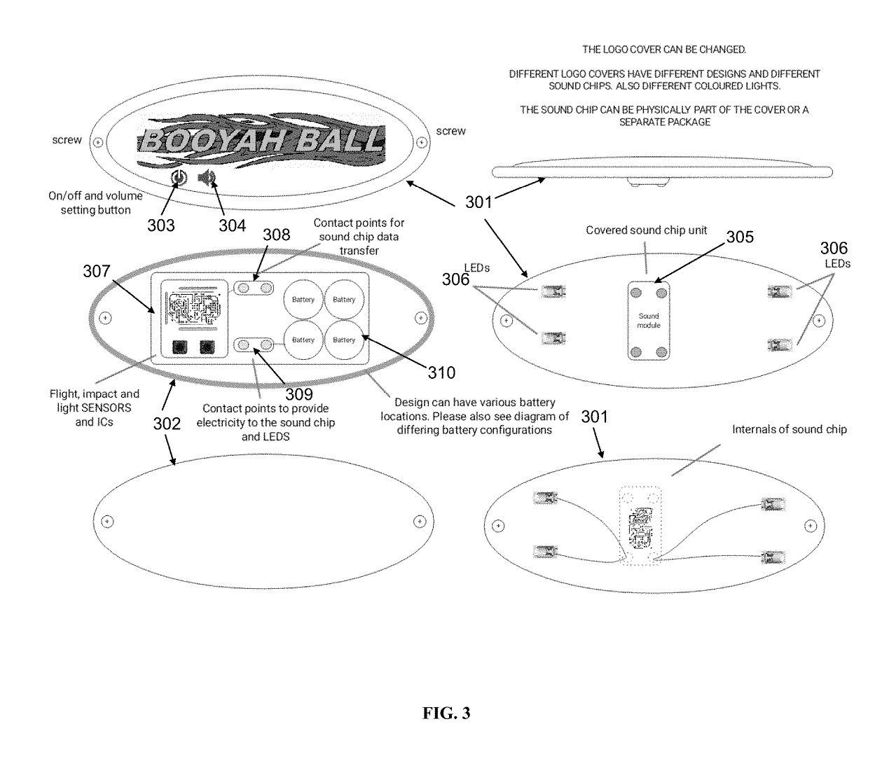

Referring to FIG. 3. In this exemplary embodiment, the logo panel comprises a top cover 301 and a bottom plate 302. A logo graphics is printed on the top surface of the top cover 301. The top surface of the top cover 301 also exposes an on/off switch 303 and a speaker volume control 304. A sound module 305, which comprises at least a memory device that stores one or more of audio data, light generation pattern data, light generation decision tree data, and audio decision tree data, and circuitries for data communication, LEDs 306, and power supply lines to the LEDs are mounted on the bottom of or within the top cover 301. Mounted on the bottom plate 302 is a printed circuit board (PCB) 307 with an integrated motion and microcontroller and contacts for the on/off switch 303 and speaker volume control 304. The printed circuit board 307 also is having contacts 308 and 309 for data communication with the sound module 305 and power supply to the sound module 305 and LEDs 306 respectively. The PCB 307 also provides the wiring connecting the batteries 310 with the rest of the components. The top cover 301 and the bottom plate 302 are joint together and secured by screws to form the logo panel. In this case, the top cover 301 is easily interchangeable with another with different logo graphics, sound module, and LED pattern and colors.

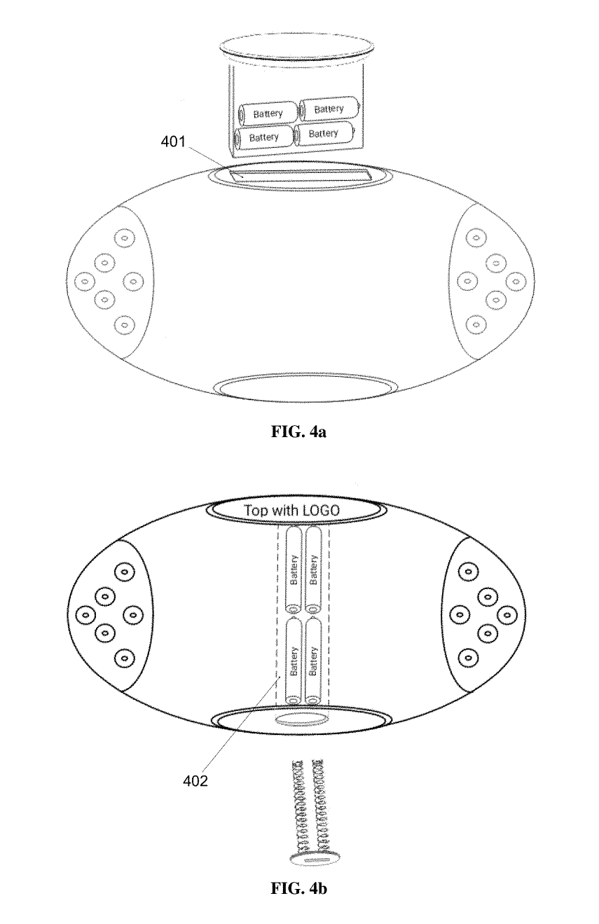

PCB 307 shown in FIG. 3 provides a placeholder-contactor for button cell batteries 310. Other arrangements of battery storage and use of different battery types are possible so long that the placement of the heavy batteries does not distort the weight balance of the projectile. For example, FIG. 4a shows a battery compartment 401 directly below where the logo panel is attached for holding cylindrical batteries. This arrangement allows access to the batteries for installation and removal by first detaching the logo panel. FIG. 4b shows another configuration of battery compartment where the battery compartment 402 is a center hollow column with an opening at the bottom, or at the opposite side to where the logo panel is attached, to allow access to the battery for installation and removal.

In accordance to another aspect, the main body internal structure of the projectile can be of solid construction, air-filled, lattice structure, construction from interlocking parts, or any combination thereof. The main body surface of the projectile can either be smooth, of lattice-like construction with holes or dents, or of a combination thereof.

In accordance to another aspect, the main body of the projectile comprises one or more compartments for the installation of the aforesaid electronic circuitries. In one exemplary embodiment, one end of the main body includes a subsurface compartment within which a speaker is secured. The compartments can also be configured to accommodate interchangeable modules. The interchangeable modules include, but not limited to, specialized electronic circuitries for special or customized functionalities such as certain LED arrangements for different lighting patterns, other light-emitting devices, more powerful speakers, light generation controllers, sound generation controllers, and extra battery packs, and peripheral accessories such as wings, fins, tails, and aerodynamic whistles, logo panels, advertisement panels, and other graphical design panels. By attaching different interchangeable modules to the compartments, the physical outlook and shape of the projectile can be changed, and its interactive lights and/or sound generation behavior can also be changed.

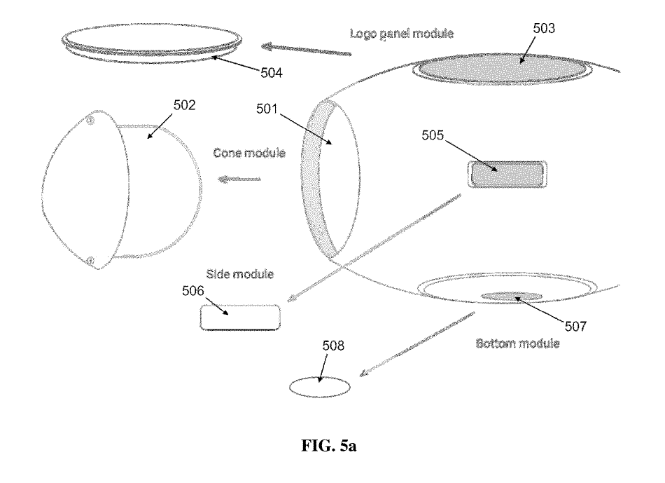

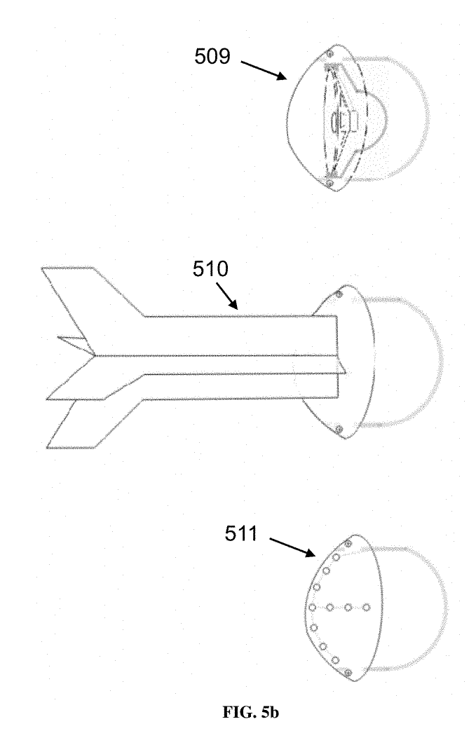

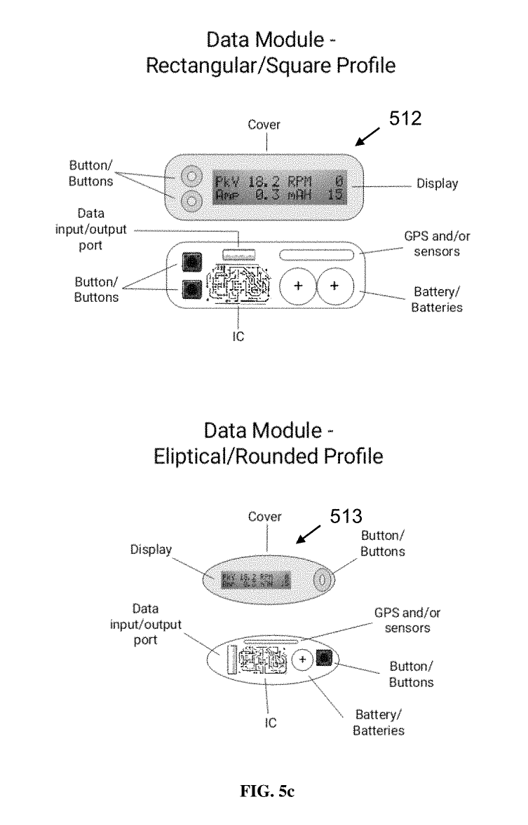

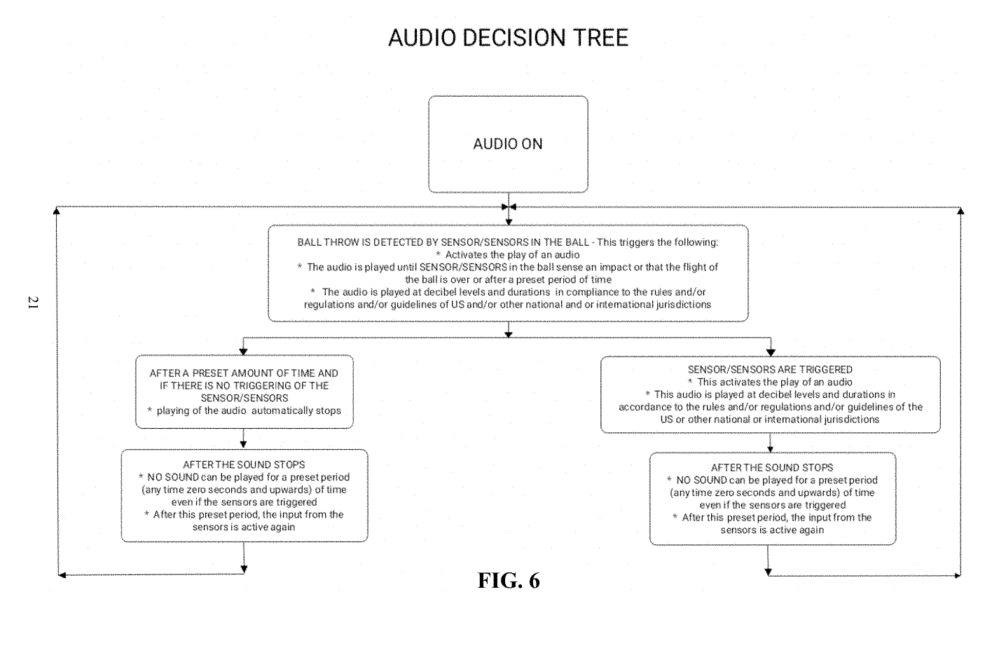

FIG. 5a shows one exemplary embodiment of the projectile having the aforesaid modularity. In this embodiment, the projectile is having a front compartment or cavity 501 to accommodate a cone module 502; a top compartment or subsurface concavity 503 to allow the attachment of a logo panel module 504; a side compartment or subsurface concavity 505 to allow the attachment of a side module 506; and a bottom compartment or subsurface concavity 507 to allow the attachment of a bottom module 508. One or more of these compartments and subsurface concavities have power and/or data communication contacts and wiring for connecting to the battery power supply and/or other electronic circuitries such as various controllers. FIG. 5b shows some exemplary embodiments of interchangeable cone module. These exemplary embodiments include a speaker module 509, a tail module 510, and a light module 511. FIG. 5c shows two exemplary embodiments of interchangeable display module 512 and 513 for attaching to the side subsurface concavity 505. Each of these side modules 512 and 513 comprises at least an electronic display (i.e. LCD display), a microcontroller or microprocessor for controlling the display contents, which may include battery power level, the projectile's flight time and speed data and the projectile's rotational speed data collected from the sensors, and button batteries for powering the components in the side module. The side modules may also provide Wi-Fi communication processing components, Bluetooth communication processing components, near field contact (NFC) communication processing components, and wired data communication ports for data communication with external systems.

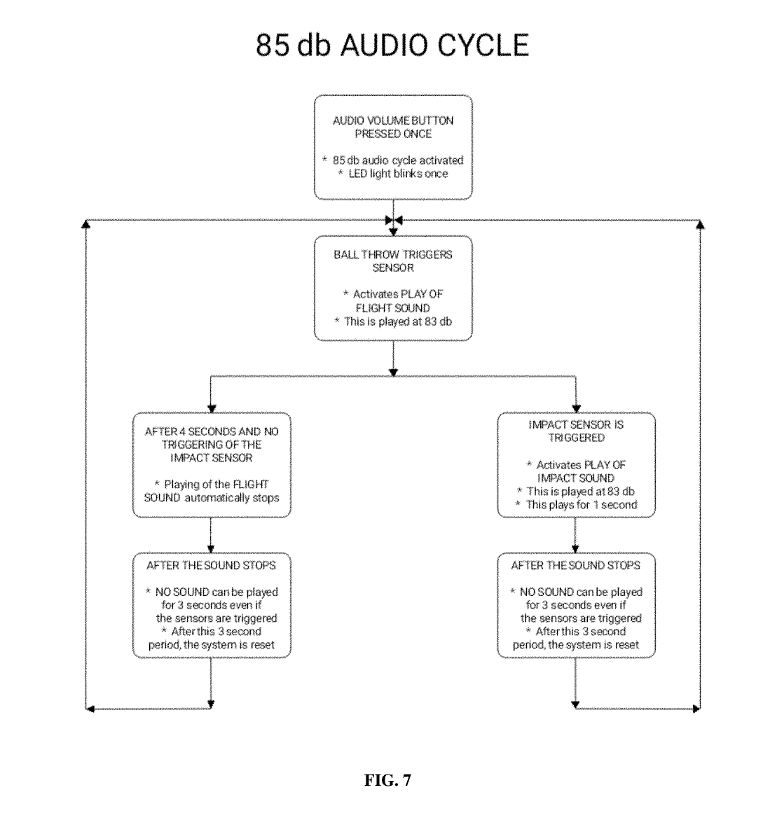

In accordance to another aspect, the sound generation is controlled by an audio decision tree implemented by one or more specialized processors with signal input from one or more motion and impact sensors and signal output driving one or more electroacoustic transducers. FIG. 6 shows one exemplary embodiment of an audio decision tree. In this audio decision tree, when the motion sensor(s) detected the projectile is being thrown, the specialized processor(s) signals the electroacoustic transducer(s) to emit a first sound until another triggering event is detected or until the lapse of a pre-configured duration of first sound. If another triggering event, such as an impact to the ground or when caught, is detected, the specialized processor(s) signals the electroacoustic transducer(s) to emit a second sound at a pre-configured loudness and for a pre-configured duration of second sound, then the sound generation ceases for a pre-configured duration of silence or rest.

On the other hand, if no triggering event is detected and the duration of first sound is lapsed, the specialized processor(s) signals the electroacoustic transducer(s) to stop and enters the duration of silence or rest in which no sound is generated.

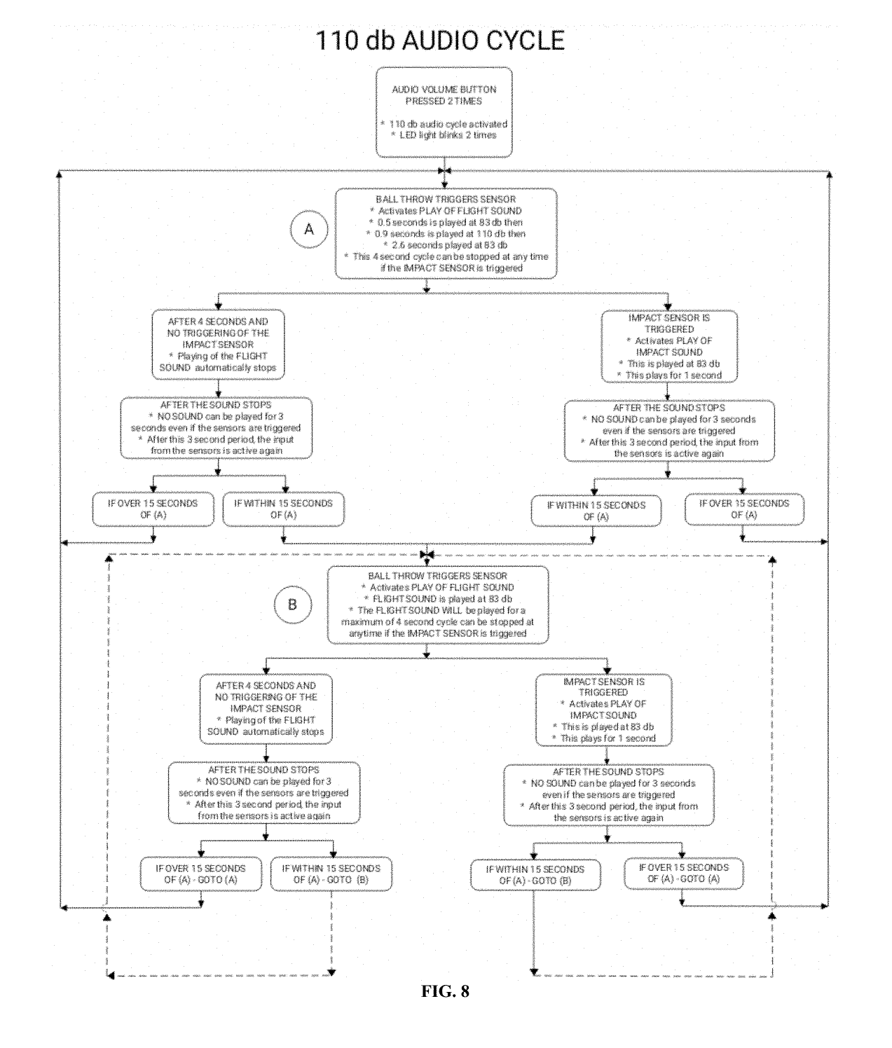

FIG. 7 shows another exemplary embodiment of an audio decision tree that is specific to an 83 db maximum loudness implementation. FIG. 8 shows yet another exemplary embodiment of an audio decision tree that is specific to an 110 db maximum loudness implementation.

In yet another embodiment, the projectile's electronic circuitries include memory devices, Wi-Fi communication processing components, Bluetooth communication processing components, near field contact (NFC) communication processing components, and/or wired data communication ports, which enable the collection and storage of real-time data such as flight time, velocity, and locations of the projectile, and the exchange of this collected data with external systems (i.e. a mobile computing device) for display and analysis.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A projectile, comprising:
a main body;
one or more electronic circuitries for performing at least one of projectile motion, impact, speed, force, rotation, gyration, and vibration sensing, interactive light and sound generation, projectile location tracking, data communication, and user control interfacing;
wherein the electronic circuitries comprising at least one of speedometers, accelerometers, impact monitors, position sensors, gyroscopic sensors, Global Positioning System (GPS) receivers, light sensors, radio transmitters, radio receivers, radio transceivers, electroacoustic transducers, audio signal processors, microcontrollers, memory devices, light-emitting devices, light-emitting device drivers, battery power supply circuitries; wireless communication processing components, near field contact (NFC) communication processing components, and wired data communication ports
wherein the projectile is in form of a spherical ball, a prolate spheroid ball, an oblate spheroid ball, a missile-shaped projectile, a tubular projectile, or a cone-shaped projectile.

2. The projectile of claim 1, wherein the projectile further comprising:
one or more compartments or cavities in the main body, each compartment or cavity is configured to accommodate and allow attachment of an interchangeable module.

3. The projectile of claim 1, further comprising:
one or more subsurface concavities around the main body, each subsurface concavity is configured to accommodate and allow attachment of an interchangeable module.

4. The projectile of claim 2, wherein the one or more interchangeable modules comprises at least one of speaker modules, light modules, and tail modules.

5. The projectile of claim 3, wherein the one or more interchangeable modules comprises at least one of logo panel modules, light modules, electronic display modules, wing modules, and fin modules.

6. The projectile of claim 5, wherein each of the logo panel modules comprises:
a sound module that includes a memory device that stores one or more of audio data, light generation pattern data, light generation decision tree data, and audio decision tree data; and
one or more light-emitting devices.

7. The projectile of claim 5, wherein each of the logo panel modules comprises:
a memory device that stores one or more of audio data, light generation pattern data, light generation decision tree data, and audio decision tree data.

8. The projectile of claim 1, wherein the sound generation is controlled by a microcontroller configured to execute an audio decision tree comprises:
generate and playback a first sound pattern for a first time period when an in-flight movement of the projectile is detected;
generate and playback a second sound pattern for a second time period when an impact on the projectile is detected;
if no impact is detected before the first time period lapses, stop the playback of the first sound pattern;
cease generation and playback of all sound patterns for a third time period after the second time period if an impact on the projectile is detected; and
cease generation and playback of all sound patterns for a third time period after the first time period if no impact on the projectile is detected.

9. The projectile of claim 1, wherein the sound generation is controlled by a microcontroller configured to execute an audio decision tree comprises:
generate and playback a first sound pattern at a first loudness level for a first time period then a second loudness level for a second time period then a third loudness level for a third time period when an in-flight movement of the projectile is detected;
generate and playback a second sound pattern for a forth time period when an impact on the projectile is detected;
if no impact is detected before the first time period lapses, stop the playback of the first sound pattern;
cease generation and playback of all sound patterns for a fifth time period after the forth time period if an impact on the projectile is detected;
cease generation and playback of all sound patterns for a fifth time period after the first time period if no impact on the projectile is detected; and
if second consecutive in-flight movement is detected within a sixth time period from the previous detection of in-flight movement, generate and playback the first sound pattern at the first loudness level for a seventh time period.

10. The projectile of claim 1, wherein the one or more electronic modules are configured to perform at least one of:
transmit a GPS location information data of the projectile to a receiver or a display;
transmit a traveling direction data of the projectile to a receiver or a display;
transmit a traveling speed data of the projectile to a receiver or a display;
transmit a rotational direction data of the projectile to a receiver or a display;
transmit a rotational speed data of the projectile to a receiver or a display; and
transmit a battery charge level data to a receiver or a display.
